(19) United States
(12) Patent Application Publication
(10) Pub. No.: US 2015/0346510 A1
(43) Pub. Date: Dec. 3, 2015

(54) TEMPLE SUPPORT

(71) Applicants: Young Chul YANG, Seoul (KR); Ji Yeon YANG, Daejeon (KR)

(72) Inventors: Young Chul YANG, Seoul (KR); Ji Yeon YANG, Daejeon (KR)

(21) Appl. No.: 14/759,362

(22) PCT Filed: Jan. 7, 2014
(86) PCT No.: PCT/KR2014/000164

§ 371 Date: Jul. 6, 2015

(30) Foreign Application Priority Data
Jan. 7, 2013 (KR) 10-2013-0001471
Jan. 7, 2013 (KR) 10-2013-0001473

(51) Int. Cl. G02C 5/14; G02C 3/00

(52) U.S. Cl. CPC G02C 5/143; G02C 3/003

(57) ABSTRACT

Disclosed is a temple support which supports a temple to prevent glasses nose pads from coming in contact with the bridge of the nose when wearing glasses, thereby reducing pressing on skin of the bridge of the nose caused by the glasses nose pads. The temple support according to the present disclosure comprises: a crescent-shaped main body portion provided at an upper bone constituting the boundary of the scalp of a wearer and the ear auricle; a fixing protrusion projected on the outer surface of the main body portion in an integrated manner. and a groove for temple insertion which is formed at the upper surface of the main body portion.

### TECHNICAL FIELD

The present disclosure in at least one embodiment relates to a temple support for eyeglasses, and more particularly to a temple support that can reduce the nose pad pressure on the skin of the bridge of the wearer's nose.

### BACKGROUND

Typical glasses are constituted by rims or a frame and a pair of temples hinged to the frame that is provided with a pair of lenses and centrally mounted nose pads.

The typical glasses in use constantly depress the skin of the wear's nose with the weight of the frame and lenses, and they block air circulation from dissipating sweat forming on the nose, which may lead to damaged skin or necrosis of the skin of the nose.

In addition, prolonged depression on the nose with the weight of the glasses may cause deformation of the face of the wearer, and especially a patient after a nasal surgery may be unable to wear the glasses.

### DISCLOSURE

### Technical Problem

Some embodiments of the present disclosure have been made in order to solve drawbacks of the related art, and to provide a temple support which can hold nose pads from touching the bridge of the nose of the wearer to reduce the nose pad pressure on the bridge skin of the wearer's nose and thereby relieve the nose from pressure sore.

Another embodiment is to provide a temple support for use with special purpose glasses of rather heavier weight, which can maintain a predetermined clearance between nose pads and the untouched skin of the wearer's nose.

Yet another embodiment seeks to provide a temple support which can be mounted on the temples of the glasses regardless of the thickness and shape of the temples.

Further embodiment is to provide a temple support which also serves as a mount for allowing accessories like earrings to be easily attached and detached.

### Summary

To achieve some objectives as above, at least one embodiment of the present disclosure provides a glasses temple support for eyeglasses, including a crescent-shaped main body 100 configured to rest atop the wearer's auricular cartilage where the auricle meets the scalp; a fixing projection 130 protruding integrally from an outer surface of the main body 100; and a temple insertion groove 120 formed on the upper side of the main body 100.

Furthermore, to achieve another objective, at least one embodiment of the present disclosure provides a temple support for eyeglasses, including a pair of crescent-shaped main bodies 210 each configured to rest atop the wearer's auricular cartilage where the auricle meets the scalp; and a pair of through grooves 220 each formed on the upper side of the main body 210.

Furthermore, to achieve yet another object, at least one embodiment of the present disclosure provides a temple support for eyeglasses, including a pair of crescent-shaped main bodies 210 each configured to rest atop the wearer's auricular cartilage where the auricle meets the scalp; a fixing projection 230 protruding integrally from the main body 210 at outer surface thereof abutting the auricle of the wearer; a through groove 220 formed internally and longitudinally of the main body 210; and a slit 240 formed through the main body 210, corresponding to an upper end of the through groove 220.

### Advantageous Effects

The temple support for eyeglasses according to at least one embodiment described above has the following advantages.

The temple support can hold nose pads from touching the wear's bridge of the nose to reduce the nose pad pressure on the bridge skin of the wearer's nose even with special purpose heavy duty glasses for, such as military operations and expedition by maintaining a predetermined clearance between nose pads and the untouched skin of the wearer's nose. Therefore, the temple support can prevent deformation of the face of the wearer due to prolonged depression on the nose under the weight of glasses.

Moreover, the temple support can be mounted on the temples of the glasses regardless of the thickness and shape of the temples while serving as a handy mount for accessories like earrings. Therefore, the temple support operatively fits any types of eyeglasses and helps the wearer to make a fashion statement.

### BRIEF DESCRIPTION OF DRAWINGS

FIGS. 1 and 4 are plan views of a glasses temple support according to the first embodiment of the present disclosure.

FIG. 2 is a side view of the temple support according to the first embodiment of the present disclosure.

FIG. 3 is a cross-sectional view of the temple support according to the first embodiment of the present disclosure.

FIGS. 5A and 5B are plan views of alternative examples of a temple insertion groove of the first embodiment illustrated in FIGS. 1-3.

FIG. 6 is an exemplary diagram of wearing the temple support according to the first embodiment of the present disclosure.

FIG. 7 is a plan view of a glasses temple support according to a second embodiment of the present disclosure.

FIG. 8 is a side view of the temple support according to the second embodiment of the present disclosure.

FIG. 9 is a perspective view of the temple support according to the second embodiment of the present disclosure.

FIG. 10 is a perspective view of the temple support according to the second embodiment of the present disclosure.

FIGS. 11A to 11B are diagrams of alternative examples of the temple support of the second embodiment illustrated in FIGS. 7-9.

### DETAILED DESCRIPTION

All terms and words used in the description and claims are not intended to be construed as being limited to the common meaning or the dictionary definition but they should be interpreted to be consistent with their meaning in the context of the relevant art and the technical idea of the disclosure, based on the principle that an inventor may properly define the meaning of the terms and words to best explain the invention.

Moreover, the embodiments described and the configurations illustrated in the drawings are merely preferred embodiments of the present disclosure and not intended to limit all of the technical idea of the present disclosure. It should be understood that various equivalents and variations are available as substitutions therefor at the time of this application.

Hereinafter, reference will be made to FIGS. 1 to 6 in describing in detail the structure and operation of the glasses temple support according to the first embodiment of the present disclosure.

### First Embodiment

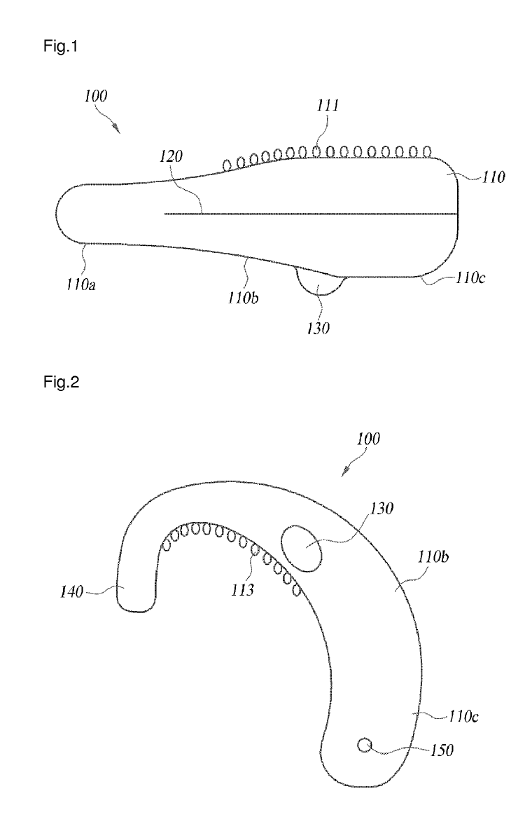

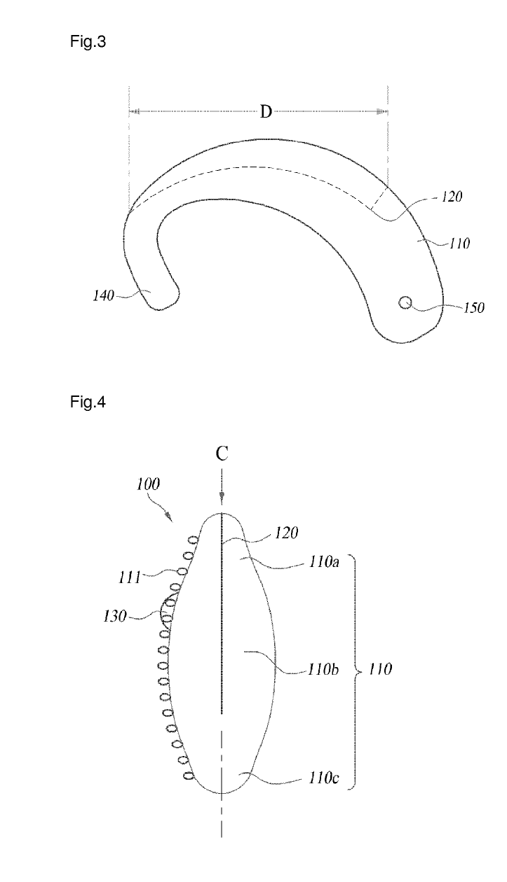

FIGS. 1 and 4 are plan views of a glasses temple support according to the first embodiment of the present disclosure, FIG. 2 a side view of the temple support, and FIG. 3 a cross-sectional view of the temple support.

Referring to FIGS. 1 to 3, a temple support for eyeglasses according to the first embodiment of the present disclosure includes a crescent-shaped main body 100, a fixing projection 130 and a temple insertion groove 120. The main body 100 is configured to rest atop the wearer's auricular cartilage where the auricle meets the scalp. The fixing projection 130 is formed integral to the main body 100 and it protrudes from an outer surface of the main body 100. The temple insertion groove 120 is formed in the main body 100 to a predetermined depth from the upper surface thereof.

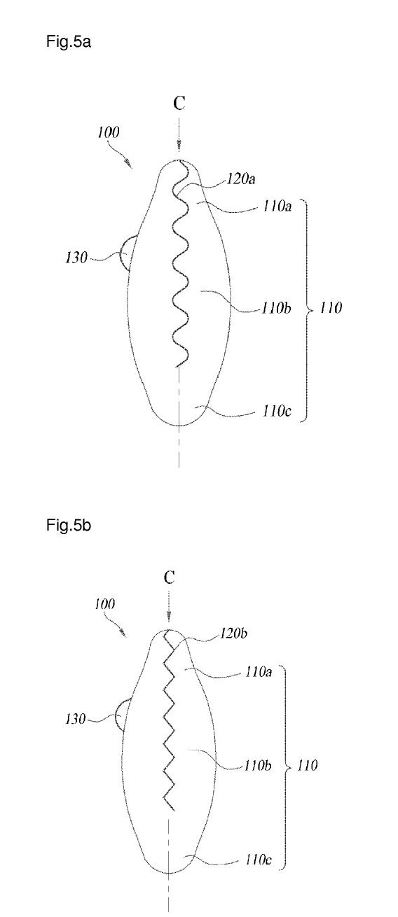

The first embodiment of the present disclosure illustrates the linear insertion groove 120 formed in the upper surface of the main body 100, although it may be modified into a sigmoid groove 120a or a zigzag groove 120b, as shown in FIGS. 5A to 5B.

The fixing protrusion 130 formed on the outer surface of the body portion 100 may have a basal circumference smaller than its body to assume a Ω-shape so that the fixing protrusion 130 is positioned to fit into a groove shape formed on the rear of the wearer's ear.

in addition, a plurality of protrusions 111 and 113 is formed on the inner surface and/or the bottom surface of the main body 100 to prevent a prolonged depression but air circulation with respect to the scalp of the wearer. in some embodiments of the present disclosure, the shape of the projections 111 and 113 is hemispherical, although it can be formed into various shapes as needed and their number and arrangement may also be varied.

The main body 100 has an intermediate portion 110b, a relatively thinner lower end portion 110c and a through hole 150 formed downwardly and distally for inserting accessories therein. The through hole 150 allows the wearer to convey a fashion sense by fixedly inserting an earring or the like and saves the wearer from having the ear pierced and the associated side effect.

The main body 100 has an upper portion 110a and has its diameter gradually increasing from the upper portion 110a toward the intermediate portion 110b while the upper portion 110a is formed with a dorsalventral section D of a predetermined length. Here, the insertion groove 120 formed on the upper surface of the main body 100 is suitable for use with a “pin-type” temple with a core wire remaining instead of plugging into a temple tip. The insertion groove 120 is configured to receive the “pin-type” temple to be inserted and seated in the dorsalventral section D on the upper portion 110a of the main body 100.

In addition, the upper tip portion of the main body 100 is formed with a hook-shaped bend 140 for allowing the main body 100 to rest atop the auricle of the wearer.

Furthermore, the main body 100 has a reference vertical center line (C) extending from the upper portion 110a to the lower end portion 110c in FIG. 4, to which the main body 100 is asymmetrically formed to customize the ergonomic fit to a particular wearer. That is, the facial side of the main body 100 may be formed to have a larger area.

The first embodiment of the present disclosure has been described as applied to a single temple support, although the same description applies equally to a pair of temple supports.

In this case, the temple support may include a pair of crescent-shaped main bodies 110 each configured to rest atop the wearer's auricular cartilage where the auricle meets the scalp; and a pair of temple insertion grooves 120 each formed on the upper sides of the main bodies 110. Here, the plurality of projections 111 and 113 may be optional depending on whether the wearer is free of a discomfort with pressure sore.

In the following, the usage and operation of the temple support will be described with reference to FIGS. 1 to 6.

First, the wearer inserts a temple of glasses in the temple insertion groove 120 as shown in FIG. 1.

Subsequently, the fixing protrusion 130 is positioned conforming to the wearer's contour at the back of the ear, and the bend 140 is put to rest over the auricle of the wearer.

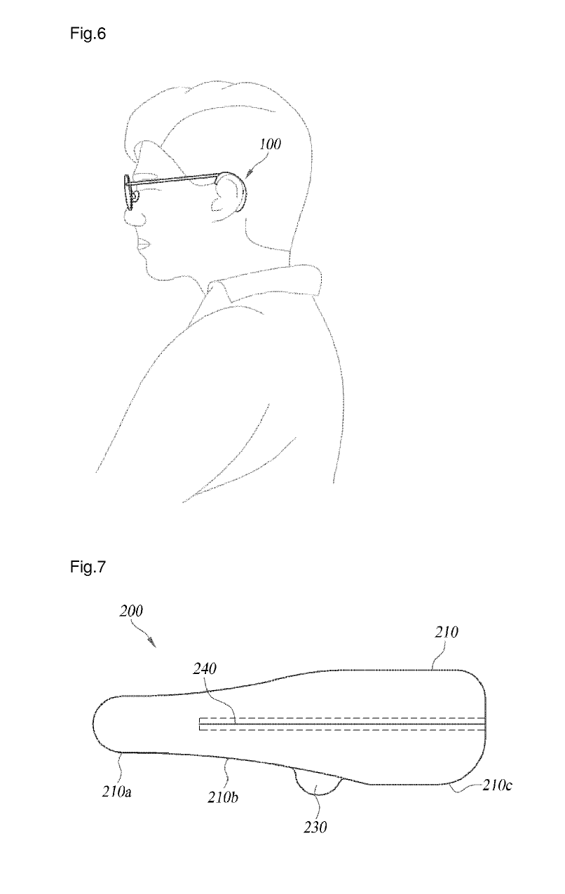

Thus, as shown in FIG. 6, the main bodies 110 of the temple support held on the wearer respectively receive the glasses temples in the insertion grooves 120 to lift up the rims and lenses of the glasses unlike the related art. This prevents the weight of the frame and lenses from imparting a pressing discomfort to the skin of the bridge of the wearer's nose. In addition, even with special purpose heavy duty glasses for, such as military operations and expedition, the temple support can keep nose pads at a predetermined clearance from touching skin of the wearer's nose.

### Second Embodiment

Referring to FIGS. 7 to 11, the configuration and operation of a temple support according to a second embodiment of the present disclosure will be described in detail.

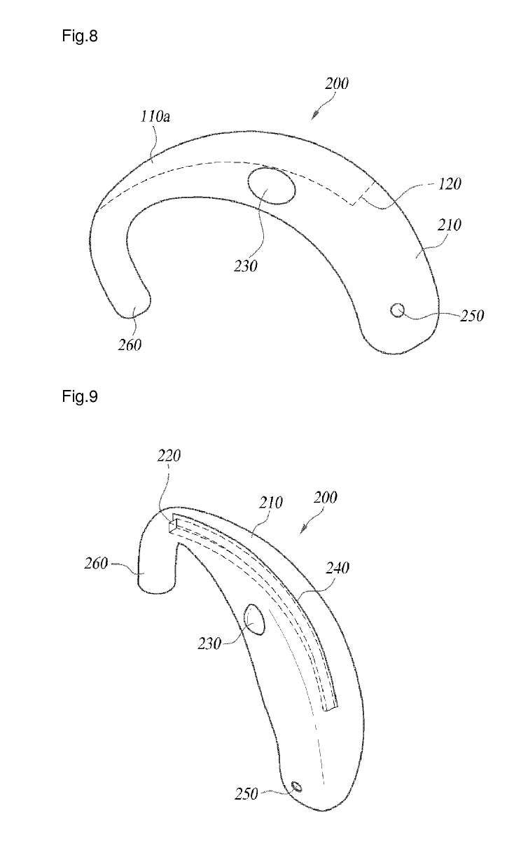

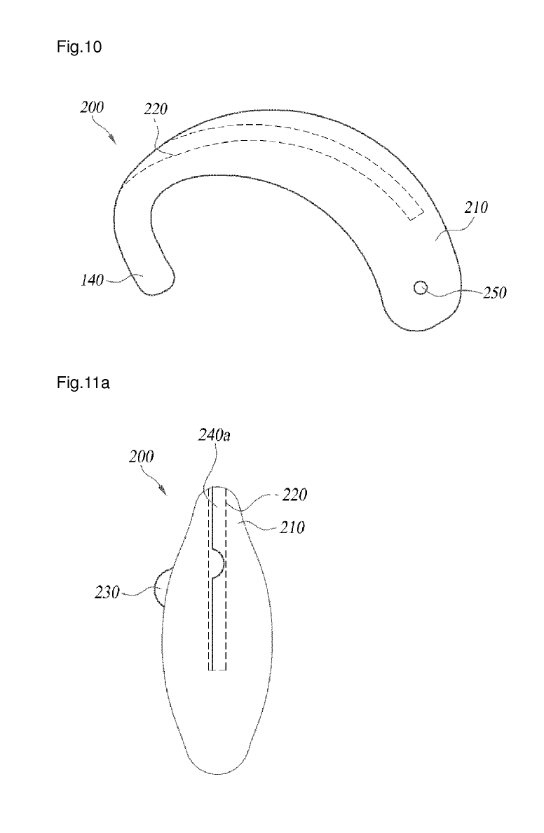

FIG. 7 is a plan view of a glasses temple support according to a second embodiment of the present disclosure, FIG. 8 a side view of the temple support, FIG. 9 a perspective view of the temple support, and FIG. 10 a perspective view of the temple support.

As illustrated in FIGS. 7 to 11, the temple support for eyeglasses according to the second embodiment of the present disclosure includes a pair of crescent-shaped main bodies 210, at least one fixing projection 230, at least one through groove 220 and at least one slit 240 formed through the main body 210 along the through groove 220. The crescent-shaped main bodies 210 are each configured to rest atop the wearer's auricular cartilage where the auricle meets the scalp. The fixing projection 230 protrudes from the main body 210 at outer surface thereof abutting the auricle of the wearer. The through groove 220 is formed internally and longitudinally of the main body 210.

In addition, a plurality of protrusions (not shown) is formed on the inner surface and/or the bottom surface of the main body 210 to prevent a prolonged depression on the scalp of the wearer.

The main body 210 has an intermediate portion 210b, a relatively thinner lower end portion 210c and a through hole 250 formed downwardly and distally for inserting accessories therein.

The main body 210 has an upper portion 210a and has its diameter gradually increasing from the upper portion 210a toward the intermediate portion 210b while the upper portion 210a is formed with a dorsalventral section of a predetermined length. Here, the insertion grooves 220 formed on the upper surface of the main body 210 is suitable for use with a temple with a core wire remaining instead of plugging into a temple tip. At this time, the slit 240 formed through the main body 210 at its upper side helps to provide a secure support for the threaded temple to rest even if it sticks out the main body 210.

In addition, the upper tip portion each of the two main bodies 210 is formed with a hook-shaped bend 260 for allowing the main body 210 to rest atop the auricle of the wearer.

Furthermore, each main body 210 has a reference vertical center line extending from the upper portion 210a to the lower end portion 210c, to which the main body 210 is asymmetrically formed.

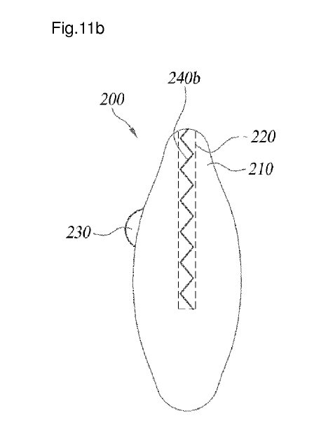

In addition, the slit 240 formed through each main body 210 may have the shape of Ω 240a in the middle as shown in FIG. 11A or the zigzag shape 240b as shown in FIG. 11B.

In the following, the usage and operation of the temple support according to the second embodiment will be described with reference to FIGS. 7 to 11.

First, the wearer inserts the temples of glasses in the pair of insertion grooves 220 as shown in FIG. 7. At this time, the insertion grooves 220 may yield to accommodate even thick temples.

Subsequently, the fixing protrusion 230 is positioned conforming to the wearer's contour at the back of the ear, and the bend 260 is put to rest over the auricle of the wearer.

Thus, as with the case of the first embodiment, the temples held on the wearer are respectively received in the insertion grooves 220 to lift up the rims and lenses of the glasses as unlike the related art. This prevents the weight of the frame and lenses from imparting a pressing discomfort to the skin of the bridge of the wearer's nose. In addition, the present temple support is wearable along with any thicknesses of temple.

The embodiments of the present disclosure disclosed herein and the drawings are merely presented to help understanding of some particular examples, and they are not intended to limit the scope of the disclosure. Besides the embodiments disclosed herein, other variations that are within the technical idea of the present disclosure can be practiced in the art to which this disclosure pertains as is obvious to those of ordinary skill.

1. A temple support for eyeglasses, comprising:
a crescent-shaped main body (100) configured to rest atop a wearer's auricular cartilage where an auricle meets a scalp;
a fixing projection (130) protruding integrally from an outer surface of the main body (100); and
a temple insertion groove (120) formed on an upper side of the main body (100).

2. The temple support of claim 1, wherein the temple insertion groove (120) formed on the upper side of the main body (100) is one of a linear groove (120), a sigmoid groove (120a) and a zigzag groove (120b).

3. The temple support of claim 1, wherein the fixing projection (130) formed on the outer surface of the main body (100) has a basal circumference smaller than the body of the fixing projection (130) to assume a Ω-shape.

4. The temple support of claim 1, further comprising a plurality of protrusions (111, 113) formed on an inner surface and/or a bottom surface of the main body (100) to prevent a prolonged depression but aft circulation with respect to the scalp of the wearer.

5. The temple support of claim 1, wherein the main body (100) has an intermediate portion (110b), a relative y thinner lower end portion (110c) and a through hole (150) formed downwardly and distally for inserting an accessory therein.

6. The temple support of claim 1, wherein the main body (100) has an upper tip portion formed with a hook-shaped bend (140) for allowing the main body (100) to rest atop the auricle of the wearer.

7. A temple support temple support for eyeglasses, comprising:
a pair of crescent-shaped main body (110) each configured to rest atop a wearer's auricular cartilage where an auricle meets a scalp; and
a pair of through grooves (120) each formed on an upper side of the main body (110).

8. A temple support for eyeglasses, comprising:
a pair of crescent-shaped main bodies (210) each configured to rest atop a wearer's auricular cartilage where an auricle meets a scalp;
a fixing projection (230) protruding integrally from the main body (210) at an outer surface thereof abutting the auricle of the wearer;
a through groove (220) formed internally and longitudinally of the main body (210); and
an upper slit (240) formed through the main body (210), corresponding to an upper end of the through groove (220).

9. The temple support of claim 8, further comprising a plurality of protrusions formed on an inner surface and/or a bottom surface of each of the main bodies (210) to prevent a prolonged depression but air circulation with respect to the scalp of the wearer.

10. The temple support of claim 8, wherein each of the main bodies (210) has an upper tip portion formed with a hook-shaped bend (260) for allowing the main body (210) to rest atop the auricle of the wearer.
